(19) United States
(12) Patent Application Publication
(10) Pub. No.: US 2024/0096140 A1
(43) Pub. Date: Mar. 21, 2024

(54) ELECTRIC VEHICLE NETWORK MANAGEMENT SYSTEM AND METHOD FOR THEREFOR

(71) Applicants: HYUNDAI MOTOR COMPANY, Seoul (KR); KIA CORPORATION, Seoul (KR)

(72) Inventor: Sung Ho Choi, Hwaseong-si (KR)

(21) Appl. No.: 18/369,400

(22) Filed: Sep. 18, 2023

(30) Foreign Application Priority Data
Sep. 20, 2022 (KR) 10-2022-0118645

(51) Int. Cl. G07C 5/00; G06F 16/23

(52) U.S. Cl. CPC G07C 5/008; G06F 16/2358

(57) ABSTRACT

An electric vehicle network management system includes a database which stores a partial network cluster database (PNC DB) of various vehicles, a server which manages the update and the download of the PNC DB and checks change information of the PNC DB in real time to transmit an update event through over-the-air (OTA) when the PNC DB is changed, and a vehicle which downloads the changed PNC DB by means of the OTA when the update event is received from the server and the vehicle includes a domain control unit (DCU) which downloads the changed PNC DB and a central communication unit (CCU) which selectively wakes up electronic control units (ECUs) of a network configuring unit which is required to execute a specific function based on the changed PNC DB.

### CROSS REFERENCE TO RELATED APPLICATIONS

This application claims priority to and the benefit of Korean Patent Application No. 10-2022-0118645 filed in the Korean Intellectual Property Office on Sep. 20, 2022, the entire contents of which are incorporated herein by reference.

### BACKGROUND

### (a) Field

The present disclosure relates to an electric vehicle network management system and a method therefor, and more particularly, to an electric vehicle network management system which minimizes or prevents the power loss by utilizing over-the-air (OTA) and a partial network (PN) and a method thereof.

### (b) Description of the Related Art

In general, vehicle manufacturers are shifting the paradigm from the existing internal combustion engine vehicle to the development of electric vehicle (X-Electrical Vehicle, xEV) and as the development of technologies such as carbon neutralization, autonomous driving, and connectivity accelerate, the number of controllers (electronic control units, ECU) in the vehicle is rapidly increasing.

This phenomenon means that the power demand increases due to the increase in the consumed current of loads in the vehicle and particularly, in the case of the xEV, it means that it is closely related to the fuel efficiency of the vehicle. In this industry, it is expected that the battery power density has a room for significant improvement in the future. However, it is difficult to increase the capacity of the battery infinitely or improve the performance, so that it is considered that the watt-seconds (power) saved in the vehicle will directly contribute to the available mileage of the xEV.

Therefore, the vehicle manufacturers are aware of the need for vehicle energy reduction and efficient energy management, and are paying attention to the development of alternative energy management systems using the vehicle's Electric/Electronic (E/E) architecture.

In-vehicle nodes (for example, ECU for every system in the vehicle) in the conventional OSEK (embedded system standard group for vehicles) NM (Network Management) manner receive the NM operation message via a controller area network (CAN) bus. In this case, the nodes receive all the messages including irrelevant messages so that the individual nodes of the CAN bus do not actively discriminate the related message and all of the nodes are activated over the CAN bus. That is, according to the conventional NM manner, when all the nodes which are connected onto the physical CAN bus topology receive the messages, only the nodes which should be woken up are not selectively woken up through the filtering, but all the networks are simultaneously woken up in response to all the messages so that there is a problem in that the energy management is inefficient.

For example, FIG. 8 schematically illustrates a network which is applied to the vehicle of the related art.

Referring to FIG. 8, the network applied to the conventional vehicle is connected to various systems, such as a chassis, a body, electronics, power transformer/power electric (PT/PE), infotainment, and autonomous driving, according to a communication protocol. Mainly, the network is configured for every domain (domain name) by the same topology and some controller (ECU) may be redundantly connected to several networks.

FIG. 9 illustrates a network configuration for every domain in the vehicle of the related art.

Referring to FIG. 9, even though there are differences among the vehicle manufacturers, the NM is mainly applied to the body/convenience devices and multimedia devices. Due to the nature of having to operate immediately when power is applied, systems related to driving, such as chassis and powertrain, are excluded from the target of NM control in a general method, and the NM control is mainly applied to systems affected by events, such as body/convenience devices or infotainment.

However, when the power is changed the OSEK NM of the related art applies the collective (entire) sleep/wake-up manner, rather than the selective sleep/wake-up manner, so that un-used controllers (ECUs) are woken-up to consume a current so that there is a problem in that unnecessary power loss is caused.

In order to solve this problem, a method for saving the energy in the vehicle by means of the selective wake-up which utilizes partial networking (PN) which are available by the improvement of the E/E architecture is being developed.

However, even though the in-vehicle energy saving method is implemented by utilizing the PN, there is a limitation that the energy saving effect using the PN function is applied only to controllers corresponding to a PN cluster group which has been configured in advance before selling the vehicle (that is, before shipment from factory). That is, there is a problem in that it is not possible to add or change a function (controller) for every PN cluster group for energy saving in a customer vehicle which has been sold (that is, after shipment from the factory).

Matters described in this background art section are prepared to enhance understanding of the background of the disclosure, and may include matters other than the related art already known to those skilled in the art to which this technique belongs.

### SUMMARY

The present disclosure attempts to provide an electric vehicle network management system which selectively controls sleep/wake-up of individual ECUs by utilizing an OTA and a partial network (PN) to expand an available mileage of an electric vehicle and a method therefor.

The present disclosure also attempts to provide an electric vehicle network management system which selectively controls start and end timings of the network by enhancing the communication connection function in a B+ power (or a regular power) also in the chassis/power electric (PE) controller to expand the available mileage of the electric vehicle and a method therefor.

According to an aspect of the present disclosure, an electric vehicle network management system includes a database which stores a partial network cluster database (PNC DB) of various vehicles, a server which manages the update and the download of the PNC DB and checks change information of the PNC DB in real time to transmit an update event through over-the-air (OTA) when the PNC DB is changed, and a vehicle which downloads the changed PNC DB by means of the OTA when the update event is received from the server and the vehicle includes a domain control unit (DCU) which downloads the changed PNC DB, and a central communication unit (CCU) which selectively wakes up electronic control units (ECUs) of a network configuring unit which is required to execute a specific function based on the changed PNC DB.

In some example embodiments, when the update event is received from the server, the DCU notifies the update event through an audio video navigation system (AVN) in the vehicle or a mobile application.

In some example embodiments, the DCU transmits an update request input from a user and downloads a changed PNC DB from the server or the database to transmit the CCU.

In some example embodiments, the CCU stores a PNC DB table in which at least one ECU required to execute a function in the vehicle, among ECUs of the network configuring unit, is mapped to a group and maintains a latest version by updating the changed PNC DB.

In some example embodiments, the CCU adds a new PNC DB group to the existing PNC DB table or changes ECU mapping information of the existing PNC DB group as an improved function of minimization of power loss is added or changed or based on the changed PNC DB.

In some example embodiments, when a PN transceiver is applied to the network configuring unit, the CCU controls selective wake-up in the unit of individual ECUs connected to a CAN bus of a gateway in a B+ power state of the vehicle.

In some example embodiments, when a network management (NM) request message is received through the PN transceiver, the CCU identifies a PNC group specified to perform the requested specific scenario and transmits the NM request message to only ECUs corresponding to the specified PNC group to be individually activated.

In some example embodiments, the PN transceiver detects the NM request message through the NM based selective wake-up function and supports the wake-up event of the network and voltage regulator activation control for the individual ECUs in the entire network configuring unit.

In some example embodiments, when the PN transceiver is not applied to the network configuring unit, the CCU wakes up all ECUs which are physically connected in the B+ power state of the vehicle and then controls the selective sleep to transmit the NM state message to only ECUs required for the requested function to maintain a non-sleep state.

According to an aspect of the present disclosure, a network management method of an electric vehicle in which a partial network (PN) transceiver is applied to a network configuring unit includes checking whether to receive an update event from a server which manages a partial network cluster database (PNC DB) of various vehicles, notifying that a changed PNC DB is updated through a vehicle terminal (AVN) or a mobile application when the update event is received, updating an existing PNC DB table by downloading the changed PNC DB through over-the-air (OTA) of the server when a user approves the update of the PNC DB, and selectively waking up the ECU by identifying an electronic control unit (ECU) of a network configuring unit required to execute a specific function based on the updated PNC DB table when it enters a fuel saving control mode for every PN scenario set in the PNC DB table.

In some example embodiments, the notifying that the changed PNC DB is updated includes inquiring to the user whether to update a PNC DB for fuel control of the vehicle by means of pop-up.

In some example embodiments, the updating of an existing PNC DB table includes adding a new PNC DB group to the existing PNC DB table or changing ECU mapping information of the existing PNC DB group based on the changed PNC DB.

In some example embodiments, the selective waking up includes identifying a PNC group specified to perform a requested specific scenario when the NM request message is received through the PN transceiver, and transmitting the NM request message to only at least one ECU corresponding to the specified PNC group to individually activate the ECU.

In some example embodiments, the NM request message includes a network bus and a destination ID corresponding to an individual ECU on which selective wake-up control is performed.

According to one aspect of the present disclosure, a network management method of an electric vehicle in which a partial network (PN) transceiver is not applied to a network configuring unit includes: checking whether to receive an update event from a server which manages a partial network cluster database (PNC DB) of various vehicles; notifying that a changed PNC DB is updated through a vehicle terminal (AVN) or a mobile application when the update event is received; updating an existing PNC DB table by downloading the changed PNC DB through over-the-air (OTA) of the server when a user approves the update of the PNC DB, and controlling selective sleep to transmit the NM state message to only at least one ECU required to execute a specific function based on the updated PNC DB table to maintain a non-sleep state after waking up all ECUs physically connected when it enters a fuel saving control mode for every PN scenario set in the PNC DB table in a B+ power state of the vehicle.

In some example embodiments, the NM state message includes a network bus and a destination ID corresponding to an individual ECU on which selective sleep control is performed.

According to the example embodiments of the present disclosure, when a function in a B+ power state of the electric vehicle is executed, the power loss when all the ECUs are woken up in the related art may be minimized by selectively waking up only essential ECUs by the PN of the NM and maintaining the remaining ECUs in the sleep state.

Further, an available mileage is increased and the fuel consumption is saved by ensuring the remaining energy of the battery in accordance with the minimization of the power loss. Further, only the essential controllers involved in the charging is activated during the charging so that the charging time may be shortened.

Further, when the mapping information of the PNC DB is changed by the system improvement, such as the minimization of the power loss, the server transmits the changed PNC DB update event of a customer vehicle and provides the changed PNC DB through the OTA to be downloaded in real time. Therefore, there is the effect of improving the customer satisfaction by securing the marketability by minimizing the power loss of the EV and maintaining the smart car service.

### BRIEF DESCRIPTION OF THE FIGURES

FIG. 1 schematically illustrates a configuration of an electric vehicle network management system according to an example embodiment of the present disclosure.

FIG. 2 illustrates a network configuration unit for enhancing the electric vehicle network management according to an example embodiment of the present disclosure.

FIG. 3 is a diagram illustrating a network management state according to an example embodiment of the present disclosure.

FIG. 4 illustrates a PNC DB table according to an example embodiment of the present disclosure and a changing method thereof.

FIGS. 5, 6, and 7 are flowcharts schematically illustrating an electric vehicle network management method according to an example embodiment of the present disclosure.

FIG. 8 schematically illustrates a network which is applied to a vehicle of the related art.

FIG. 9 illustrates a network configuration for every domain in the vehicle of the related art.

### DETAILED DESCRIPTION

In the following detailed description, only certain example embodiments of the present disclosure have been shown and described, simply by way of illustration.

The term used herein is for the purpose of describing specific embodiments only and is not intended to limit the disclosure. As used herein, the singular forms are intended to include the plural forms as well, unless the context clearly indicates otherwise. The terms “comprise” and/or “comprising”, when used herein, specify the presence of recited features, integers, steps, operations, components and/or components, but it will also be understood that the terms do not exclude the presence or addition of one or more of the features, integers, steps, operations, elements, components and/or groups thereof. As used herein, the term “and/or” includes any one or all combinations of the associated listed items.

Throughout the specification, the terms, such as first, second, A, B, (a), (b), may be used to describe various components, but the components should not be limited by the terms. The terms are used to distinguish the component from another component, but do not limit the nature, sequence, or order of the component.

Throughout the specification, when a component is referred to as being ‘connected’ or ‘coupled’ to another component, it should be understood that although it may be directly connected or coupled to the other component, another components may be provided therebetween. On the other hand, when a component is referred to as ‘directly connected’ or ‘directly coupled’ to another component, it should be understood that no other component is provided therebetween.

Additionally, it is understood that one or more of the following methods or aspects thereof may be executed by at least one controller. The term “controller” may refer to a hardware device including a memory and a processor. The memory is configured to store the program instructions and the processor is specifically programmed to execute the program instructions so as to perform one or more processes which will be described below in more detail. As described herein, the controller may control operations of units, modules, components, devices, or those similar thereto. Further, it is also understood that the methods below may be executed by a device that includes a controller along with one or more other components, as will be appreciated by those skilled in the art.

Further, the controller of the present disclosure may be implemented by non-transitory computer readable recording media including executable program instructions executed by a processor. Examples of the computer-readable recording media includes ROMs, RAMs, compact disk (CD) ROMs, magnetic tapes, floppy disks, flash drives, smart cards, and optical data storage devices, but are not limited thereto. The computer-readable recording media may also be distributed throughout a computer network so that program instructions may be stored and executed in a distributed manner, such as, a telematics server or a controller area network (CAN).

Now, an electric vehicle network management system according to an example embodiment of the present disclosure and a method thereof will be described in detail with reference to the drawing.

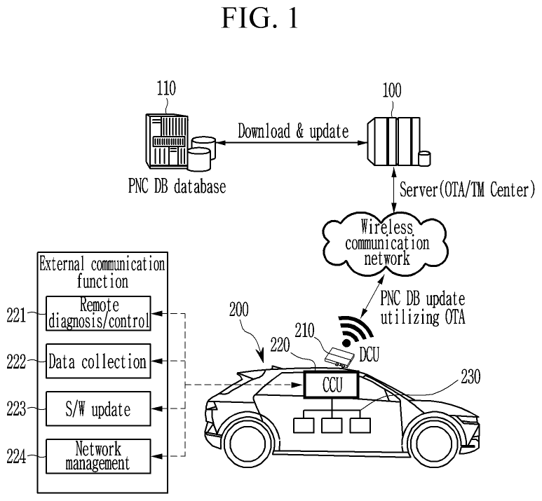

FIG. 1 schematically illustrates a configuration of an electric vehicle network management system according to an example embodiment of the present disclosure.

Referring to FIG. 1, an electric vehicle network management system according to an example embodiment includes a database 110 which stores PN cluster (partial network cluster, or PNC) databases (DBs) of various vehicles, a server 100 which manages the updating and downloading of the PNC DB, checks PNC DB change (added/deleted) information for a client vehicle in real time to transmit an update event through over-the-air (OTA) when there is a change, and a vehicle 200 which downloads the changed PNC DB through the OTA when the update event is received from the server 100. The vehicle 200 includes a domain control unit (DCU) 210 which downloads the changed PNC DB and a vehicle controller (central communication unit CCU) 220 which selectively wakes up controllers (electronic control units, ECUs) of the network configuration unit 230 required to execute a specific function based on the downloaded PNC DB.

The database 110 is loaded in a separate server to supply the PNC DB to the vehicle 200 in a cloud computing manner or is integrated with the server 100. The PNC DB refers to ECU information belonging to one or more PNC groups which are configured in advance in the vehicle to minimize the power loss (that is, energy saving) of the vehicle 200.

The server 100 provides a vehicle network management service which updates the improved PNC DB to the database 110 to minimize the power loss of the vehicle 200 and transmits an update event to the vehicle 200 through the OTA to guide the vehicle 200 to download.

For example, the server 100 may be implemented to be expanded by adding a wireless software update and vehicle network management service function utilizing the OTA to the system of a telematics center which provides a remote diagnosis or control service for safe and efficient operation of the vehicle 200 sold to a customer. However, the example embodiment is not limited thereto and the server 100 may be implemented by an independent OTA server for the vehicle network management service.

Particularly, as described above, according to the related art, the available mileage expansion efficiency may be achieved by saving the battery energy of the EV by utilizing the PN, but the PN efficiency may be applied only to the ECUs corresponding to the PNC group which has been configured in advance before selling the vehicle. Therefore, according to the related art, there is a problem in that it is not possible to add or change a new function in the EV which has been sold.

Accordingly, the server 100 according to the example embodiment provides a feature on demand (FoD) which allows a portable terminal or a vehicle of a client to download and utilize a new function through the OTA after selling the vehicle or activates (permits) a function which has been already mounted, but is locked (or limited) by a software application (S/W) to the vehicle.

That is, the server 100 may monitor the change of the PNC DB generated by adding a new function to the sold vehicle 200 of the customer or changing the existing function and distributes the changed PNC DB through the OTA.

In the example embodiments, the vehicle 200 refers to an electric vehicle EV unless otherwise specified and includes a vehicle to load (V2L) function which uses the power of the mounted battery by connecting the battery to the outside.

The DCU 210 is a wireless communication modem which supports the external communication of the vehicle 200 and connects the server 100 and the wireless communication. The DCU 210 supports at least one of commercial mobile communication (for example, 4G or 5G) and V2X (Vehicle-to-Everything) communication. Further, the example embodiment is not limited thereto and various types of mobile communication techniques which will be described to be applicable to the vehicle may be applied.

The DCU 210 receives the update event from the server 100 as the PNC DB is changed to notify (pop-up) it through the audio video navigation system (AVN) in the vehicle or a mobile application.

The DCU 210 transmits an update request input from the user and downloads the changed PNC DB from the server 100 or the database 110 to transmit the changed PNC DB to the CCU 220.

The CCU 220 controls an overall operation which manages the network to prevent the power loss of the vehicle according to the example embodiment and includes at least one program and data for the control.

When the CCU 220 receives the downloaded PNC DB through the DCU 210, the CCU manages to maintain the latest version by updating the downloaded PNC DB to the existing PNC DB table.

The CCU 220 performs at least one function of remote diagnosis/control 221, data collection 222, S/W update 223, and network management 224 using the external communication of the DCU 210.

The remote diagnosis/control 221 includes a function of transmitting state information which is collected during the driving of the vehicle to the server 100 to perform the real-time diagnosis and changing a control condition of the vehicle based on the diagnosis result received from the server 100 or supporting the remote control at the time of emergency situation.

The data collection 222 includes a function of collecting external data via the V2X communication to support an autonomous driving mode of the vehicle or an advanced driver assistance system (ADAS) mode equivalent thereto.

The S/W update 223 includes an OTA function of updating the software by itself by determining a condition for entering the wireless software S/W update when the power is turned off after the vehicle stops and transmitting the result to the mobile application of the user when the update is completed.

The network management 224 includes a function of updating the changed PNC DB to add the power loss prevention function from the server 100 when the power is turned off after the vehicle stops, by utilizing the OTA function.

Particularly, one object of the network management 224 according to the example embodiment is to manage an associated function between the ECUs which are configuration nodes of the network configuring unit 230 and enhance start, end, and error processing functions of the network in more advanced form.

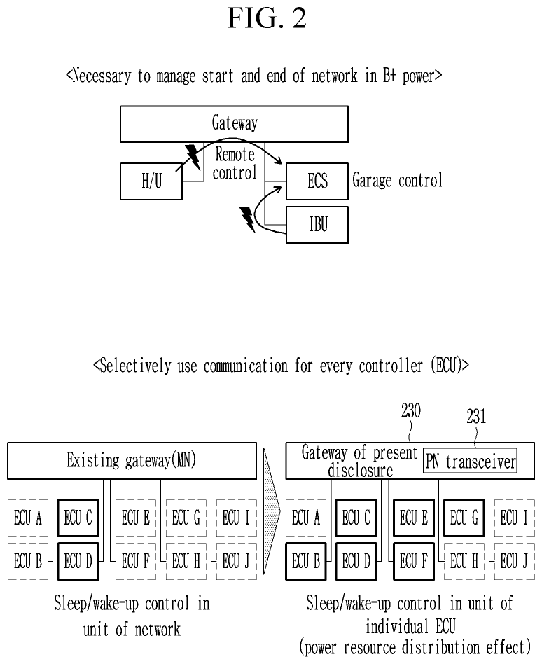

FIG. 2 illustrates a network configuration unit for enhancing the electric vehicle network management according to an example embodiment of the present disclosure.

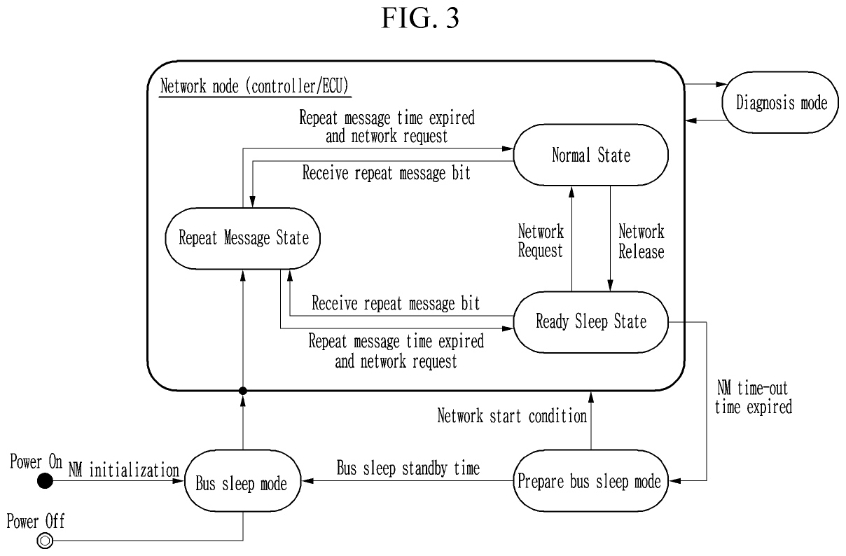

FIG. 3 is a diagram illustrating a network management state according to an example embodiment of the present disclosure.

Referring to FIGS. 2 and 3, a network configuring unit 230 according to the example embodiment of the present disclosure has a structure in which ECUs are connected to a plurality of network buses CAN configured in the gateway. The ECU included in the same network bus has its own ID (source) and a destination ID (destination) in accordance with the connected order.

As illustrated in FIG. 3, all network ECUs (nodes) which are included in the network configuring unit 230 to follow the network management (NM) algorithm performs the network activity in accordance with a previously defined state, such as a repeat message state, a normal state, and a ready sleep state.

The NM algorithm uses an NM message which is periodically repeated and an NM message which is transmitted from any ECU is received to all the ECUs in the corresponding cluster.

Here, when the NM message is received, it means that an ECU at the transmission side wants to maintain a currently woke-up state of the NM cluster.

If any ECU is in a ready sleep state in which it is completed to be ready to enter the bus sleep mode, it is ready to be shifted to the bus sleep mode in a state in which the transmission of the NM message is stopped and the reception of the NM message transmitted from another ECU is maintained.

When there is no more NM message reception and a timer time allocated to be ready for the sleep mode has passed, all the ECUs start to be shifted to the bus sleep mode.

Further, in the bus sleep mode state, any ECU in the NM cluster transmits the NM message for request for the communication so that the NM cluster is woken up.

The network management 224 function of the CCU 220 is to manage a network start and end timing by enhancing a communication connection function in a B+ power state for chassis/PE (power electric) related controllers (ECUs) to expand an available mileage in the EV architecture, unlike the power architecture of the internal combustion engine vehicle of the related art.

This is because as a value of the electric vehicle EV as a living space has emerged beyond the concept of a transportation means, unlike the internal combustion engine vehicle of the related art, even in a starting off situation after stopping, ECUs required to execute the newly added functions such as body control, chassis control, scheduled charging or V2L need to be maintained in an active state. However, according to the NM method of the related art, sleep/wake-up function is performed in the unit of networks by means of the CAN bus connected to the gateway so that it has a drawback in that all the ECUs including unnecessary ECUs are activated to cause the power loss.

Therefore, the CCU 220 according to the example embodiment of the present disclosure applies a PN transceiver 231 to the network configuring unit 230 to control selective wake up/sleep in the unit of individual ECUs connected to the CAN bus of the gateway.

That is, the CCU 220 individually activates only the corresponding ECU by utilizing the PN transceiver 231 to allow only the ECUs which perform the control related to a specific function by means of the predetermined NM request message to receive the message. Here, when the ECUs are individually activated, it is defined as “selective wake-up”.

The PN transceiver 231 detects the NM request message by the NM based selective wake-up function and supports the network wake-up event and voltage regulator activation control of the individual ECU in the entire network configuring unit 230. A configuration of the PN transceiver 231 is changed by updating the software (S/W) by the server 100.

An architecture of the PN transceiver 231 has a structure in which a reception path of the CAN protocol controller including a clock source is integrated to implement the selective wake-up function.

The biggest advantage of the PN transceiver 231 is that it allows the function to be continuously used even though the ignition of the existing vehicle is turned off without consuming the battery due to the unnecessary standby current.

Accordingly, according to the example embodiment of the present disclosure, unlike the NM manner of the related art, the gateway 230 activates individually only the related ECU through the predetermined NM request message by utilizing the PN transceiver 231 to minimize the power loss by efficiently controlling the power resource. Further, the communication bus load and the CPU load are also reduced.

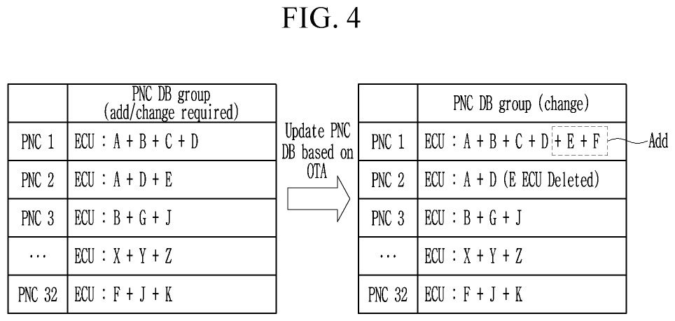

FIG. 4 illustrates a PNC DB table according to an example embodiment of the present disclosure, and an updating method thereof.

Referring to FIG. 4, the CCU 220 stores the PNC DB table in which at least one ECU required to execute the function of the vehicle, among ECUs configured in the network configuring unit 230 is mapped as a group and manages the PNC DB table to maintain the latest version by updating the changed PNC DB.

The CCU 220 adds a new PNC DB group in the existing PNC DB table or changes the ECU mapping information of the existing PNC DB group based on the downloaded PNC DB as the improved function for minimization of the power loss of the vehicle 200 is added or changed.

That is, as illustrated in FIG. 4, when it is necessary to add/change the previously stored PNC DB table according to the update event received from the server 100, the CCU 220 adds another ECU to the PNC1 group or deletes a specific ECU from a PNC2 group based on the PNC DB downloaded through the OTA. Further, the CCU 220 may update the PNC DB based on the OTA which adds a PNC DB group in which at least one ECU is grouped as the new function is added.

In the meantime, a method of preventing the power loss of the electric vehicle by utilizing the PNC DB updated in the network configuring unit 230 by the CCU 220 according to the example embodiment of the present disclosure is mainly implemented by two example embodiments that the PN transceiver is applied as described above and the PN transceiver is not applied.

Hereinafter, two example embodiments of the present disclosure will be described by assuming a scheduled charging scenario PNC1 while the electric vehicle is stopped. Here, the scenario refers to a control logic designed by considering a given condition when a specific function of the vehicle is executed.

According to the PNC1 scenario, when only four ECUs including a BMS (Battery Management System), a LDC (Low voltage DC Converter), a PDC (Power-net Domain Controller) and a VCU (Vehicle Control Unit) are woken up, a DB is set in advance to perform the scheduled charging at a time set by the user while the vehicle is stopped.

However, when the vehicle camping which customers have recently enjoyed is considered, if the customers want to simultaneously charge the vehicle and operate an air-conditioning (air conditioner/heater) function to avoid the heat or cold in the camping site, the function cannot be implemented with the current PNC configuration.

With the existing PNC configuration, it is necessary to select a method to operate the air conditioning system and perform charging in a state in which all ECUs are woken up, like NM before PN was applied. However, this is disadvantageous not only in terms of energy saving, but also in terms of time to perform charging and a billing system.

Therefore, if the necessary functions of these customers are identified to add them as a scenario to the PNC DB as one of the new FoD functions, user convenience is increased and the power consumption is minimized by simultaneously performing charging and waking up essential convenience devices individually even when camping.

### First Example Embodiment

A first example embodiment of the present disclosure, a power loss minimizing method when a PN transceiver in which selective wake-up function and an active type PN function are available is applied will be described.

The CCU 220 selectively wakes up only an individual ECU belonging to a designated PNC1 to perform the scheduled charging scenario when the NM request message is received through the PN transceiver 231.

For example, if a driver wants to perform scheduled charging on an electric vehicle at a predetermined time, only four ECUs of BMS, LDC, PDC, and VCU which perform the charging related functions in the corresponding PNC1 are woken up. When the user executes a function of the air conditioner, ECUs belonging to the PNC group related to the corresponding function are identified from the PNC DB table to selectively wake up the ECUs.

According to the first example embodiment of the present disclosure, when the PN transceiver is applied, only individual ECUs required to perform the function, among ECUs included in a specific PNC, are selectively woken-up to be activated and the remaining ECUs maintain the sleeping state to implement the highest energy efficiency.

### Second Example Embodiment

Unlike the first example embodiment, according to a second example embodiment of the present disclosure has a structure in which the PN transceiver is not applied so that only four ECUs which perform the charging management function in the PNC1 cannot be selectively woken up.

Therefore, when the PN transceiver 231 is not applied, the CCU 220 controls the selective sleep to wake up all the ECUs which are physically connected and then maintain non-sleep state of only four ECUs of BMS, LDC, PDC and VCU which perform the charging related function in the PNC1.

That is the CCU 220 has a structure that the PN transceiver 231 is not applied so that only four ECUs belonging to the PNC1 cannot be selectively woken up so that after waking up all the ECUs which are connected to a physical network, a NM state message is transmitted to the four ECUs. By doing this, the four ECUs monitor the NM state message to maintain the active state without entering the sleep state. The remaining ECUs excluding four ECUs, among all the woken-up ECUs do not have the received NM state message so that the remaining ECUs enter a sleep standby mode and are naturally shifted to the sleep after a predetermined sleep stand-by time has been elapsed.

According to the second example embodiment of the present disclosure, even in the situation in which the PN transceiver is not applied, after activating all the ECUs of the network, only individual ECUs necessary to execute a specific function maintain the active state and the remaining ECUs enter the sleep to reduce the power loss.

The CCU 220 of the vehicle 200 according to the example embodiment of the present disclosure may be implemented by one or more processors which operate by a set program and the set program is programmed to perform steps of an electric vehicle network management method according to the example embodiment of the present disclosure.

The electric vehicle network management method will be described in more detail with reference to the following drawings.

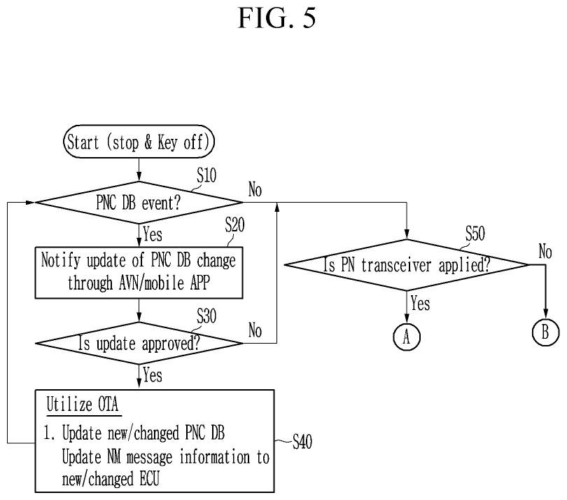

FIGS. 5 to 7 are flowcharts schematically illustrating an electric vehicle network management method according to an example embodiment of the present disclosure.

First, referring to FIG. 5, a flow of updating a PNC using an OTA according to an example embodiment of the present disclosure is illustrated.

The PNC update method using an OTA according to the example embodiment of the present disclosure starts in a vehicle stop and key-off state.

The CCU 220 of the vehicle 200 checks whether an update event is received from a server 100 which manages a partial network cluster (PNC) DB of various vehicles in the stop and key-off state in step S10.

In this case, when the update event is received (Yes in step S10), the CCU 220 notifies (pop-up) that the changed PNC DB is updated through the vehicle terminal (AVN) or a mobile application in step S20 and inquires the user whether the PNC DB is updated for fuel control of the vehicle through the pop-up in step S30. For example, the inquiry may pop-up that “Do you want to update PNC DB for fuel control”.

When the user approves the PNC DB update (Yes in step S30), the CCU 220 downloads the changed PNC DB through the OTA of the server 100 to update the existing PNC DB table and updates NM message information corresponding to newly added/changed ECU in step S40. Thereafter, the CCU 220 returns to step S10.

In contrast, when the PNC DB update event is not received or there is no un-processed update information (No in step S10), the CCU 220 performs the network management (NM) control for every ECU in the vehicle according to the power loss minimization algorithm.

When the CCU 220 performs the network management (NM) control method, as described above, depending on whether the PN transceiver 231 is applied to the network configuring unit 230, the control according to the first example embodiment or the second example embodiment may be performed in step S50.

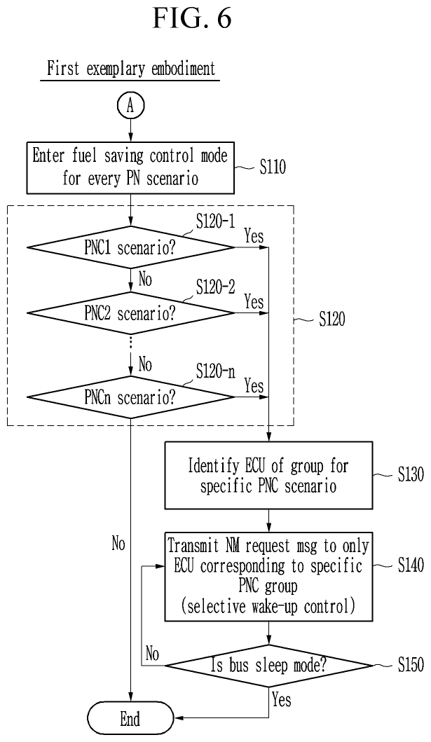

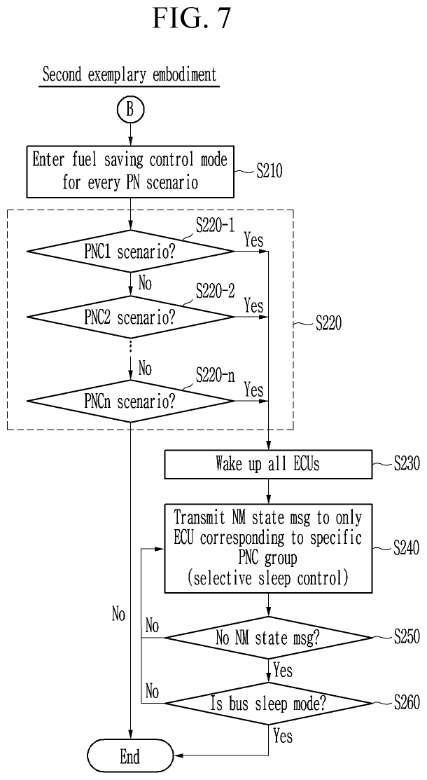

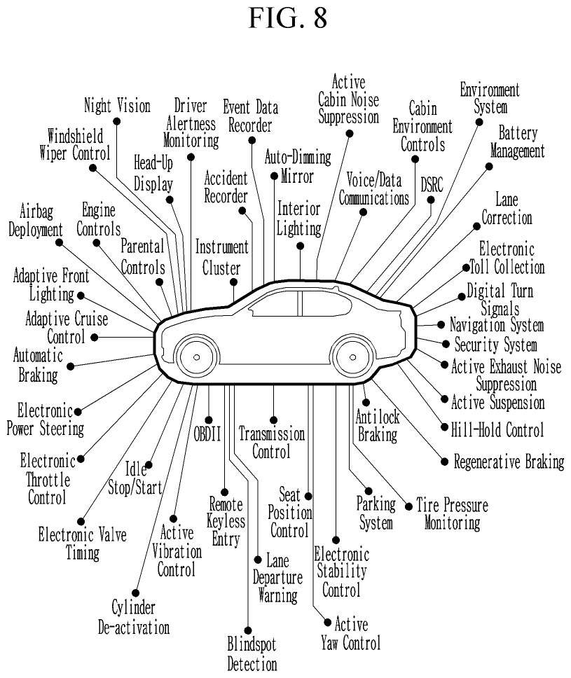

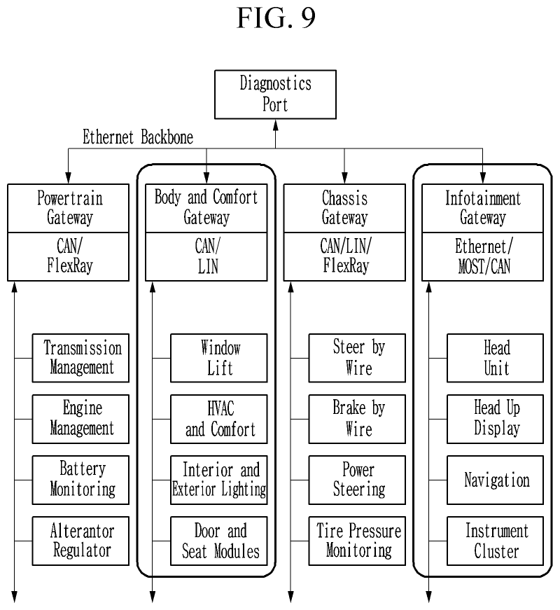

Hereinafter, when the PN transceiver is applied (Yes in step S50), the network management method according to the first example embodiment will be described with reference to FIG. 6 and when the PN transceiver is not applied (No in step S50), the network management method according to the second example embodiment will be described with reference to FIG. 7.

First, FIG. 6 is a flowchart illustrating an electric vehicle network management method when the PN transceiver is applied, according to the first example embodiment of the present disclosure.

Referring to FIG. 6, when the PN transceiver 231 is applied to the network configuring unit 230, the CCU 220 enters into a fuel saving control mode for every predetermined PN scenario in a B+ power state of the vehicle in step S110.

When the NM request message is received through the PN transceiver 231, the CCU 220 of the vehicle 200 identifies a designated PNC group to perform the requested specific scenario in step S120.

Hereinafter, the specific scenario is assumed as a scheduled charging scenario for power loss minimization defined in the PNC1 (Yes in step S120-1).

The CCU 220 identifies ECUs of a PNC1 group set to perform the scheduled charging scenario, among a plurality of PNCs PNC1 to PNCn set in the updated PNC DB table in step S130 and transmits the NM request message to only at least one ECU corresponding to the PNC1 group to perform selective wake-up control to individually activate in step S140. In response to the selective wake-up control, only four ECUs of BMS, LDC, PDC and VCU which perform charging related functions are activated and the remaining ECUs maintain the sleep state. The NM request message may include the network bus CAN and the destination ID corresponding to the individual ECUs on which the selective wake-up control will be performed.

Thereafter, after completing the scheduled charging scenario, the CCU 220 checks whether the ECUs enter a bus sleep mode in step S150.

If the ECUs do not enter the sleep mode (No in step S150), the CCU 220 maintains the current selective wake-up control state in step S140 and if the ECUs enter the sleep mode standby state (Yes in step S150), the CCU allows the ECU to be shifted to the sleep mode after the sleep mode standby time has elapsed.

Further, in step S120, when there is no PNC group specified to perform the requested specific scenario (all no in step S120), the CCU 220 ends the corresponding PN control and if necessary, guides the update of the PNC DB for PN control through the VPN or the mobile application.

In the meantime, FIG. 7 is a flowchart illustrating an electric vehicle network management method when the PN transceiver is not applied, according to the second example embodiment of the present disclosure.

Referring to FIG. 7, when the PN transceiver 231 is not applied to the network configuring unit 230, the CCU 220 enters the fuel saving control mode for every PN scenario set in the B+ power state of the vehicle in step S210.

When the NM request message is received through the existing NM transceiver, the CCU 220 identifies the PNC group specified to perform the requested specific scenario in step S220.

Hereinafter, the specific scenario is assumed as a scheduled charging scenario for power loss minimization defined in the PNC1 (Yes in step S220-1).

Here, the CCU 220 has a structure in which the PN transceiver is not applied so that the selective wake-up cannot be performed, unlike the first example embodiment, so that the CCU 220 wakes up all the ECUs connected to the physical network in step S230. The CCU 220 performs the selective sleep control which transmits the NM state message to only at least one ECU corresponding to the PNC1 group based on the updated PNC DB table to maintain the non-sleep state in step S240. The NM state message may include the network bus CAN and the destination ID corresponding to the individual ECUs on which the selective sleep control will be performed.

Thereafter, the ECUs which receive the NM state message according to the selective sleep control maintain the active state (No in step S250), the ECU which does not receive the NM state message is stand-by for the bus sleep mode (Yes in step S250) and is naturally shifted to the sleep mode after the sleep mode standby time has elapsed (Yes in step S260).

Further, in step S220, when there is no PNC group specified to perform the requested specific scenario (all no in step S220), the CCU 220 ends the corresponding NM control and if necessary, guides the user to update the PNC DB for NM control.

As described above, according to the example embodiments of the present disclosure, when a function in a B+ power state of the electric vehicle is executed, the power loss when all the ECUs are woken up in the related art may be minimized by selectively waking up only essential ECUs by the PN of the NM and maintaining the remaining ECUs in the sleep state.

Further, an available mileage is increased and the fuel consumption is saved by ensuring the remaining energy of the battery in accordance with the minimization of the power loss. Further, only the essential ECUs involved in the charging is activated during the charging so that the charging time may be shortened.

Further, according to the related art, the limited energy saving is possible only for the PNC group which is configured in advance before selling the vehicle and when the mapping information of the partial network cluster (PNC) DB is changed due to the change in the feature on demand (FoD) or a system internal specification, it is not possible to flexibly respond thereto in real time.

In contrast, according to the example embodiment of the present disclosure, when the mapping information of the PNC DB is changed by the system improvement, such as the minimization of the power loss, the server transmits the changed PNC DB update event of a client vehicle and provides the changed PNC DB through the OTA to be downloaded in real time. Therefore, there is the effect of improving the customer satisfaction by securing the marketability by minimizing the power loss of the EV and maintaining the smart car service.

The example embodiment of the present disclosure is not implemented only through the devices and/or methods described above, but may be implemented through a program for realizing functions corresponding to the configuration of the embodiment of the present disclosure or a recording medium on which the program is recorded, and the like. This implementation can be easily implemented by an expert in the technical field to which the present disclosure belongs from the description of the above-described embodiment.

While this disclosure has been described in connection with what is presently considered to be practical example embodiments, it is to be understood that the disclosure is not limited to the disclosed example embodiments. On the contrary, it is intended to cover various modifications and equivalent arrangements included within the spirit and scope of the appended claims.

1. An electric vehicle network management system, comprising:
a database configured to store a partial network cluster database (PNC DB) of various vehicles;
a server configured to manage an update and a download of the PNC DB, and and to check change information of the PNC DB in real time to transmit an update event through over-the-air (OTA) when the PNC DB is changed; and
a vehicle configured to download the changed PNC DB by the OTA when the update event is received from the server;
wherein the vehicle includes:
a domain control unit (DCU) configured to download the changed PNC DB; and
a central communication unit (CCU) configured to wake up a plurality of electronic control units (ECUs) of a network configuring unit, the network configuring unit being configured to execute a specific function based on the changed PNC DB.

2. The electric vehicle network management system of claim 1, wherein when the update event is received from the server, the DCU notifies the update event through an audio video navigation system (AVN) in the vehicle or a mobile application.

3. The electric vehicle network management system of claim 1, wherein the DCU transmits an update request input from a user and downloads a changed PNC DB from the server or the database to transmit the CCU.

4. The electric vehicle network management system of claim 1, wherein the CCU stores a PNC DB table, wherein at least one ECU required to execute a function in the vehicle, among ECUs of the network configuring unit, is mapped to a group and maintains a latest version by updating the changed PNC DB.

5. The electric vehicle network management system of claim 4, wherein the CCU adds a new PNC DB group to an existing PNC DB table or changes ECU mapping information of the existing PNC DB group when an improved function of minimization of power loss is added or changed or based on the changed PNC DB.

6. The electric vehicle network management system of claim 1, wherein when a PN transceiver is applied to the network configuring unit, the CCU controls selective wake-up in the unit of individual ECUs connected to a CAN bus of a gateway in a B+ power state of the vehicle.

7. The electric vehicle network management system of claim 6, wherein when a network management (NM) request message is received through the PN transceiver, the CCU identifies a PNC group specified to perform a requested specific scenario, and transmits the NM request message to only ECUs corresponding to the specified PNC group to be individually activated.

8. The electric vehicle network management system of claim 6, wherein the PN transceiver detects an NM request message through an NM based selective wake-up function, and supports a wake-up event of the network and voltage regulator activation control for the individual ECUs in the network configuring unit.

9. The electric vehicle network management system of claim 1, wherein when a PN transceiver is not applied to the network configuring unit, the CCU wakes up all ECUs that are physically connected in the B+ power state of the vehicle, and then controls selective sleep to transmit an NM state message to only ECUs required for the requested function to maintain a non-sleep state.

10. A network management method of an electric vehicle in which a partial network (PN) transceiver is applied to a network configuring unit, comprising:
checking, by a central communication unit, whether to receive an update event from a server configured to manage a partial network cluster database (PNC DB) of various vehicles;
notifying, by the central communication unit, that a changed PNC DB is updated through a vehicle terminal (AVN) or a mobile application when the update event is received;
updating, by the central communication unit, an existing PNC DB table by downloading the changed PNC DB through over-the-air (OTA) of the server when a user approves the update of the PNC DB; and
selectively waking up, by the central communication unit, an electronic control unit (ECU) by identifying the ECU of a network configuring unit required to execute a specific function based on the updated PNC DB table when the network configuring unit enters a fuel saving control mode for every PN scenario set in the PNC DB table.

11. The network management method of an electric vehicle of claim 10, wherein the notifying that the changed PNC DB is updated includes inquiring the user whether to update a PNC DB for fuel control of the vehicle by means of pop-up.

12. The network management method of an electric vehicle of claim 10, wherein the updating of an existing PNC DB table includes adding a new PNC DB group to the existing PNC DB table, or changing ECU mapping information of the existing PNC DB group based on the changed PNC DB.

13. The network management method of an electric vehicle of claim 10, wherein the selectively waking up includes:
identifying a PNC group specified to perform a requested specific scenario when an NM request message is received through the PN transceiver; and
transmitting the NM request message to only at least one ECU corresponding to the specified PNC group to individually activate the ECU.

14. The network management method of an electric vehicle of claim 13, wherein the NM request message includes a network bus and a destination ID corresponding to an individual ECU on which selective wake-up control is performed.

15. A network management method of an electric vehicle in which a partial network (PN) transceiver is not applied to a network configuring unit, comprising:
checking, by a central communication unit, whether to receive an update event from a server which manages a partial network cluster database (PNC DB) of various vehicles;
notifying, by the central communication unit, that a changed PNC DB is updated through a vehicle terminal (AVN) or a mobile application when the update event is received;
updating, by the central communication unit, an existing PNC DB table by downloading the changed PNC DB through over-the-air (OTA) of the server when a user approves the update of the PNC DB; and
controlling, by the central communication unit, selective sleep to transmit an NM state message to only at least one ECU required to execute a specific function based on the updated PNC DB table to maintain a non-sleep state after waking up all ECUs physically connected when the central communication unit enters a fuel saving control mode for every PN scenario set in the PNC DB table in a B+ power state of the vehicle.

16. The network management method of an electric vehicle of claim 15, wherein the NM state message includes a network bus and a destination ID corresponding to an individual ECU on which selective sleep control is performed.
